(19) United States
(12) Patent Application Publication
(10) Pub. No.: US 2025/0342616 A1
(43) Pub. Date: Nov. 6, 2025

(54) Video Generation Method and Apparatus, Storage Medium, and Electronic Device

(71) Applicant: Tencent Technology (Shenzhen) Company Limited, Shenzhen (CN)

(72) Inventors: Quande Liu, Shenzhen (CN); Xin Wang, Shenzhen (CN)

(21) Appl. No.: 19/264,557

(22) Filed: Jul. 9, 2025

Related U.S. Application Data
(63) Continuation of application No. PCT/CN2024/094602, filed on May 22, 2024.

(30) Foreign Application Priority Data
Jul. 26, 2023 (CN) 2023109234935

(51) Int. Cl. G06T 11/00; G06T 7/246; G06V 20/40; G06V 30/18

(52) U.S. Cl. CPC G06T 11/00; G06T 7/246; G06V 20/46; G06V 30/18

(57) ABSTRACT

This application discloses a video generation method and apparatus, a storage medium, and an electronic device. The method includes: obtaining a content description text and a content reference video, the content description text including information for describing target content expressed by a target video that is expected to be generated, and the content reference video including action reference information related to the target content; performing feature extraction on the content description text, to obtain text semantic features, the text semantic features being configured for representing semantic information of the content description text; performing feature extraction on the content reference video, to obtain video reference features, the video reference features being configured for representing the action reference information in the content reference video; and generating the target video based on the text semantic features and the video reference features. This application can improve quality of the generated target video.

### CROSS-REFERENCE TO RELATED APPLICATIONS

This application is a Continuation Application of PCT Application PCT/CN2024/094602, filed May 22,2024, which claims priority to Chinese Patent Application No. 202310923493.5, filed Jul. 26, 2023, each entitled “Video Generation Method and Apparatus, Storage Medium, and Electronic Device” each of which is incorporated by reference in its entirety.

### FIELD

Aspects described herein relates to the field of artificial intelligence, and in particular, to the field of computer vision technologies.

### BACKGROUND

In a video generation scenario, an artificial intelligence (AI for short) model is usually used to generate a series of images based on an inputted content description text, and further use the series of images to form a coherent video.

The content description text in the foregoing manner is specifically configured for generating an image rather than directly configured for generating a video. As generation processes of images are independent of each other, generated images are prone to weak coherence. Correspondingly, in a video formed by using the images, significant jitter may occur between consecutive frames, affecting quality of the generated video, that is, the quality of the generated video is poor.

### SUMMARY

Aspects described herein provide a video generation method and apparatus, a storage medium, and an electronic device.

According to an aspect of aspects described herein, a video generation method is provided, which is performed by an electronic device, and includes the following operations:
obtaining a content description text and a content reference video, the content description text comprising information for describing target content expressed by a target video that is expected to be generated, and the content reference video comprising action reference information related to the target content;
performing feature extraction on the content description text, to obtain text semantic features, the text semantic features being configured for representing semantic information of the content description text; and performing feature extraction on the content reference video, to obtain video reference features, the video reference features being configured for representing the action reference information in the content reference video; and
generating the target video based on the text semantic features and the video reference features.

According to another aspect of aspects described herein, a video generation apparatus is further provided, including:
a first obtaining unit, configured to obtain a content description text and a content reference video, the content description text comprising information for describing target content expressed by a target video that is expected to be generated, and the content reference video comprising action reference information related to the target content;
an extraction unit, configured to: perform feature extraction on the content description text, to obtain text semantic features, the text semantic features being configured for representing semantic information of the content description text; and perform feature extraction on the content reference video, to obtain video reference features, the video reference features being configured for representing action reference information in the content reference video; and
a generation unit, configured to generate the target video based on the text semantic features and video reference features.

According to still another aspect of aspects described herein, a computer-readable storage medium is provided, including a program stored therein, the program, when run by an electronic device, performing the foregoing video generation method.

According to still another aspect of aspects described herein, a computer program product or a computer program is provided, the computer program product or the computer program including computer instructions, and the computer instructions being stored in a computer-readable storage medium. A processor of a computer device reads the computer instructions from the computer-readable storage medium, and executes the computer instructions, so that the computer device performs the foregoing video generation method.

According to still another aspect of aspects described herein, an electronic device is further provided, including a memory, a processor, and a computer program stored in the memory and capable of being run on the processor, the processor performing the foregoing video generation method by using the computer program.

Aspects described herein includes: obtaining a content description text and a content reference video, the content description text including information for describing target content expressed by a target video that is expected to be generated, and the content reference video including action reference information related to the target content; performing feature extraction on the content description text, to obtain text semantic features, the text semantic features being configured for representing semantic information of the content description text; performing feature extraction on the content reference video, to obtain video reference features, the video reference features being configured for representing the action reference information in the content reference video; and generating the target video based on the text semantic features and the video reference features. In aspects described herein, the content description text is configured for describing the target content expressed by the target video that is expected to be generated, and the content reference video with a video coherence characteristic is configured for providing a reference for the target content. In this way, in a process of generating the target video, the action information in the content reference video with coherence can be fully referred to, so that actions in the generated video content are more coherent, that is, the generated target video has better coherence. In this way, a higher-quality outputted video is obtained, thereby achieving a technical effect of improving video obtaining accuracy.

### BRIEF DESCRIPTION OF THE DRAWINGS

The accompanying drawings described herein are used to provide a further understanding described herein, and form a part described herein. Illustrative aspects described herein and descriptions thereof are used to explain aspects described herein, and do not constitute a limitation. In the accompanying drawings:

FIG. 1 is a schematic diagram of an application environment of a video generation method according to an aspect described herein.

FIG. 2 is a schematic flowchart of a video generation method according to an aspect described herein.

FIG. 3 is a schematic diagram of a video generation method according to an aspect described herein.

FIG. 4 is a schematic diagram of another video generation method according to an aspect described herein.

FIG. 5 is a schematic diagram of another video generation method according to an aspect described herein.

FIG. 6 is a schematic diagram of another video generation method according to an aspect described herein.

FIG. 7 is a schematic diagram of another video generation method according to an aspect described herein.

FIG. 8 is a schematic diagram of another video generation method according to an aspect described herein.

FIG. 9 is a schematic diagram of another video generation method according to an aspect described herein.

FIG. 10 is a schematic diagram of a video generation apparatus according to an aspect described herein.

FIG. 11 is a schematic structural diagram of an electronic device according to an aspect described herein.

### DETAILED DESCRIPTION

To make a person skilled in the art understand solutions described herein better, the following clearly and completely describes the technical solutions in aspects described herein with reference to the accompanying drawings in aspects described herein. The described aspects are merely a part rather than all of aspects described herein. All other aspects obtained by persons of ordinary skill in the art based on aspects described herein without creative efforts shall fall within the protection scope described herein.

In the specification, claims, and accompanying drawings described herein, the terms “first”, “second”, and the like are intended to distinguish similar objects but do not necessarily indicate a specific order or sequence. Data used in this way may be interchanged in a proper circumstance, so that aspects described herein described herein can be implemented in a sequence different from those shown in the drawings or described herein. In addition, the terms “include” and “have” and any variants thereof are intended to cover non-exclusive inclusion, for example, a process, method, system, product, or device that includes a series of operations or units is not necessarily limited to those clearly listed operations or units, but may include another operation or unit that is not clearly listed or is inherent to the process, method, product, or device.

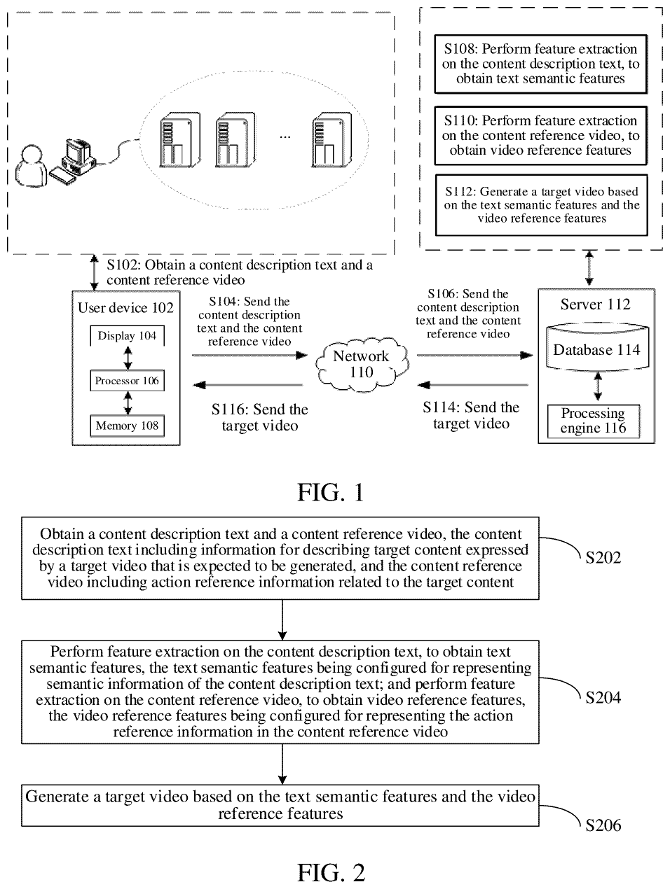

According to an aspect of aspects described herein, a video generation method is provided. In an aspect, in an implementation, the foregoing video generation method may be applied to, but is not limited to, an environment shown in FIG. 1. The environment may include, but is not limited to, a user device 102 and a server 112. The user device 102 may include a display 104, a processor 106, and a memory 108. The server 112 may include a database 114 and a processing engine 116.

A specific process may be as follows:

Operation S102: The user device 102 obtains a content description text and a content reference video.

Operation S104 to operation S106: The user device 102 sends the content description text and the content reference video to the server 112 through a network 110.

Operation S108 to operation S112: The server 112 performs, by using the processing engine 116, feature extraction on the content description text, to obtain text semantic features, performs feature extraction on the content reference video, to obtain video reference features, and further generates a target video based on the text semantic features and the video reference features.

Operation S114 to operation S116: The server 112 sends the target video to the user device 102 through the network 110, the user device 102 displays the target video on the display 104 through the processor 106, and stores the target video in the memory 108.

In addition to the example shown in FIG. 1, the foregoing operations may alternatively be independently completed by the user device or the server, or may be cooperatively completed by the user device and the server. For example, the user device 102 performs the foregoing operations such as S108 to S112, thereby reducing processing pressure of the server 112. The user device 102 includes, but is not limited to, a handheld device (such as a mobile phone), a notebook computer, a tablet computer, a desktop computer, an on-board device, a smart television, and the like. This application does not limit a specific form of the user device 102. The server 112 may be an individual server, or may be a server cluster including a plurality of servers, or may be a cloud server.

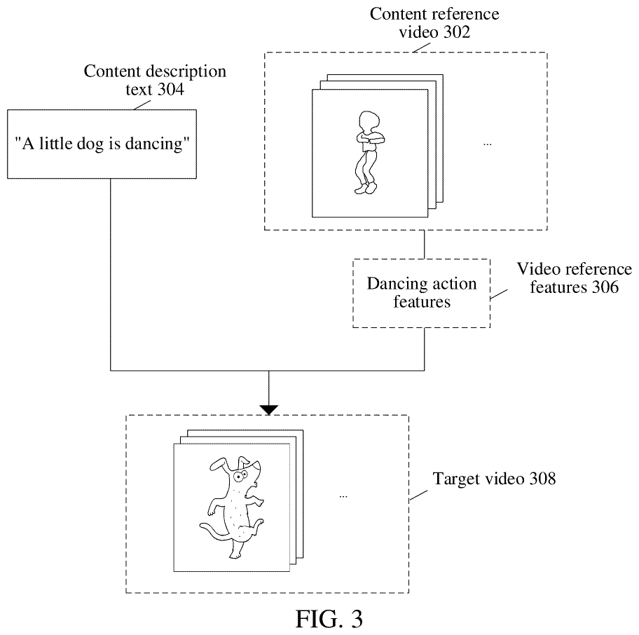

In an aspect, as in an implementation, as shown in FIG. 2, the video generation method may be performed by an electronic device, for example, the user device or the server shown in FIG. 1. Specific operations include the following:
S202: Obtain a content description text and a content reference video, the content description text including information for describing target content expressed by a target video that is expected to be generated, and the content reference video including action reference information related to the target content.
S204: Perform feature extraction on the content description text, to obtain text semantic features, the text semantic features being configured for representing semantic information of the content description text; and perform feature extraction on the content reference video, to obtain video reference features, the video reference features being configured for representing the action reference information in the content reference video.
S206: Generate a target video based on the text semantic features and the video reference features.

In this aspect, the video generation method may be applied to, but is not limited to, an application scenario of artificial intelligence generated content (AIGC for short). The AIGC refers to an artificial intelligence technology that can generate new content, audio, and images, for example, an AI-generated image, and an AI-generated video. In this aspect, the content description text and the content reference video are combined, to support a user to input the content reference video and generate video content with reference to the content description text, so that controllability and generation quality of the generated video content can be effectively improved.

In this aspect, the content description text describing the target content expressed by the target video that is expected to be generated may relate to information about aspects such as an object, a scenario, an action, and an emotion in the video.

For further example, a general description of an entire video may be provided by using a content description text, including basic information such as a subject, a scenario, time, and a place of the video, for example, “A red car passes by in the image”. Alternatively, an action or a behavior of an object (such as a person or an object) in the video is described by using a content description text, for example, “A little dog chases a ball”. Alternatively, an emotional color of video content is evaluated by using a content description text, for example, “A sweet family moment is presented”. Alternatively, a scenario or an environment in which the video is presented is described by using a content description text, for example, “A beautiful beach is presented in the video”. Alternatively, events or changes occurring in the video are described in chronological order by using a content description text, for example, “At the beginning, the sun slowly rises, and later a spectacle sunset appears”.

In this aspect, to improve relevance between the inputted content description text and the outputted target video, in a video generation process, the content reference video used as a reference for the target content may be used, for example, a content description text is “A little dog chases a ball”, and a content reference video presents a series of actions of a little cat chasing a ball. In this case, the content description text and the content reference video may be combined, to finally generate a target video presenting a series of actions of a little dog chasing a ball, and the series of actions presented by the target video may be, but is not limited to being, similar to or the same as the series of actions presented by the content reference video.

In this aspect, the text semantic features are configured for representing semantic information of the content description text, that is, semantic information used by the content description text to describe the target content, and may be, but is not limited to, an expression manner of meanings and information carried in the content description text, for example, a meaning and an implication of the text reflected in aspects such as word selection, word meaning, and part of speech in a text; logical and semantic associations between sentences can be reflected by a sentence structure, a syntax rule, and an association relationship between words in the text; and a context, a tone, an emotional color in the text, a subject and a topic related to the text, related technical field knowledge, and the like.

In this aspect, the video reference features are configured for representing key information of the content reference video that provides reference for the target content, that is, are configured for representing the action reference information in the content reference video. To improve coherence of the target video, the video reference features may be, but are not limited to, features meeting a dynamic characteristic condition; and/or, the key information may correspond to, but is not limited to being corresponding to, key content in the target content, where the key content may be, but is not limited to, dynamic content.

For further example, as shown in FIG. 3, by combining a content reference video 302 and a content description text 304, a target video 308 presenting a little dog dancing is generated. By performing feature extraction on the content reference video 302, video reference features 306 may be obtained, which are, but are not limited to, dance action features in the content reference video 302. The dance action features in the content reference video 302 are extracted as the video reference features 306 because, firstly, the dance action features meet a dynamic characteristic condition, and secondly, “dancing” in the content description text 304 “A little dog is dancing” is also dynamic content, and “dancing” corresponds to the dance action features. Therefore, the dance action features in the content reference video 302 are extracted as the video reference features 306.

In this aspect, the target video is generated based on the text semantic features and the video reference features. For example, the text semantic features provide a theme, content, and a keyword of a video that is expected to be generated, then at least one video element is obtained based on the video theme, the content, and the keyword; and the action reference features provided by the video reference features are used, to instruct to generate a key video element in the video element, to obtain the target video. The text semantic features ensure consistency between the target video and the target content that is expected to be generated, and the video reference features ensure video quality of the target video.

The target content expressed by the video that is expected to be generated is described by using the content description text, and the content reference video with a video coherence characteristic is used as a reference for the target content. In this way, generated video content has a better coherence characteristic, which improves relevance between the inputted content description text and the outputted target video, thereby achieving a technical effect of improving video generation accuracy, and generating a video of high quality.

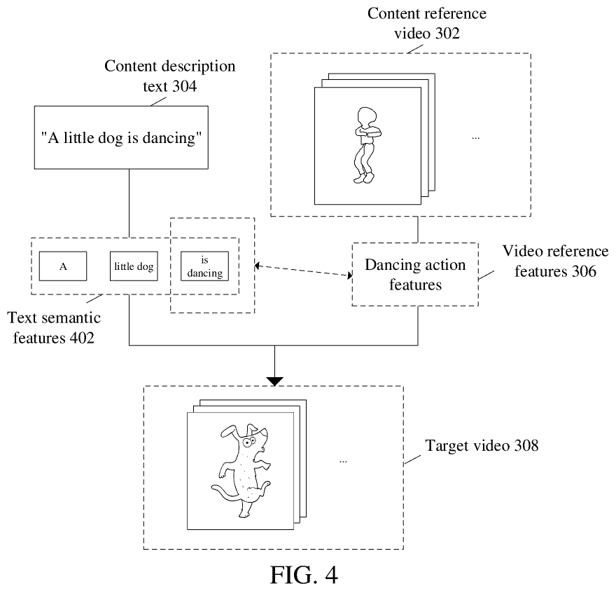

For further example, in an aspect, based on the scenario shown in FIG. 3, and as shown in FIG. 4, the method includes: generating the content description text 304 and the content reference video 302, the content description text 304 including information for describing target content expressed by the video that is expected to be generated, and the content reference video 302 including action reference information for providing a reference to the target content; performing feature extraction on the content description text 304, to obtain text semantic features 402, the text semantic features 402 being configured for representing semantic information that describes the target content by the content description text 304; performing feature extraction on the content reference video 302, to obtain video reference features 306, the video reference features 306 being configured for representing the action reference information that the content reference video 302 provides a reference for the target content, for example, key information that provides a video generation reference for “dancing” in the target content is the dancing action information in the content reference video 302; and generating the target video 308 based on the text semantic features 402 and the video reference features 306.

This aspect provided described herein includes: obtaining a content description text and a content reference video, the content description text including information for describing target content expressed by a target video that is expected to be generated, and the content reference video including action reference information related to the target content; performing feature extraction on the content description text, to obtain text semantic features, the text semantic features being configured for representing semantic information of the content description text; performing feature extraction on the content reference video, to obtain video reference features, the video reference features being configured for representing the action reference information in the content reference video; and generating the target video by using the text semantic features and the video reference features. The content description text is configured for describing the target content expressed by the video that is expected to be generated, and the content reference video with a video coherence characteristic is used as a reference for the target content. In this way, in a process of generating the target video, the action information in the content reference video with coherence can be fully referred to, so that actions in the generated video content are more coherent, that is, the generated target video has better coherence. In this way, a higher-quality outputted video is obtained, thereby achieving a technical effect of improving video generation accuracy.

In a solution, generating the target video based on the text semantic features and the video reference features includes the following operations:
S1-1: Determine at least one video element in the target video based on the text semantic features, the at least one video element including a first subject object.
S1-2: Determine a posture change situation of the first subject object in the target video based on the video reference features.
S1-3: Generate the target video based on the at least one video element and the posture change situation of the first subject object in the target video.

In this aspect, at least one video element displayed in the target video is determined by using the text semantic features, for example, a content description text “A little dog is dancing on the football field”. Then, based on text semantic features obtained by performing feature extraction on the content description text, one little dog is required as a subject object (the first subject object) in a video that is expected to be generated, and a football field is used as a video background. Both the little dog and the football field can be considered as video elements.

In this aspect, the posture change situation may be, but is not limited to, a change of a posture, a location, or a shape of an object (such as an object or a human body) in (target video) space, such as a displacement change (a location of the object in the space changes, which may be a translation, rotation, or staggered motion along a linear or curved path), a posture change (when the object is in a static or moving state, a partial or entire posture of a body changes, such as bending, extending, or twisting), or a shape change (an outline of the object changes, such as a size change, deformation, or expansion caused by compression or stretching).

In general, the posture change situation is a key attribute for determining whether a video is coherent, or whether video presentation is coherent is highly associated with the posture change situation. However, in this aspect, to further improve coherence of the target video, the posture change situation of the first subject object in the target video is determined by using the video reference features, so that the posture change situation in the target video better conforms to a characteristic of the video, and the generated target video has higher quality.

For further example, in an aspect, for example, location distribution and an element form of the at least one video element on each video frame in the target video are determined, and the location distribution and the element form of the first subject object on each video frame in the target video are dynamically targeted and adjusted based on the posture change situation of the first subject object in the target video, so that a finally presented effect of the target video is not limited to a set of a plurality of image frames, but better conforms to the posture change with a video characteristic, that is, a target video with higher coherence is presented.

This aspect provided described herein includes: determining at least one video element in the target video based on the text semantic features, the at least one video element including the first subject object; determining the posture change situation of the first subject object in the target video based on the video reference features; and generating the target video based on the posture change situation of the at least one video element and the first subject object in the target video. In this way, a target video with higher coherence is presented, thereby achieving a technical effect of improving video quality of the target video.

In a solution, the performing feature extraction on the content reference video, to obtain video reference features includes the following operation:
performing feature extraction on a second subject object in the content reference video, to obtain object representation features, object representation features being configured for representing a posture change situation of the second subject object in the content reference video, and video reference features comprising the object representation features.

The determining a posture change situation of the first subject object in the target video based on the video reference features includes the following operation:
determining the posture change situation of the first subject object in the target video based on the object representation features, the posture change situation of the first subject object in the target video corresponding to the posture change situation of the second subject object in the content reference video.

In this aspect, the posture change situation of the first subject object in the target video corresponds to the posture change situation of the second subject object in the content reference video. For example, as shown in FIG. 4, a posture change situation of a figure (the second subject object) during dancing in the content reference video 302 corresponds to a posture change situation of a dog (the first subject object) during dancing in the target video 308.

Based on a correspondence of the posture change situations between the existing content reference video and the target video that is expected to be generated, video quality of the target video is improved. In other words, the posture change situation of the first subject object in the target video is obtained through restoration based on the posture change situation of the second subject object in the content reference video. In other words, the posture change situation of the first subject object in the target video may be a series of target actions performed by the first subject object in the target video, and the series of target actions may be the same as or similar to a series of actions performed by the second subject object in the content reference video.

This aspect provided described herein includes: performing feature extraction on the second subject object in the content reference video, to obtain object representation features, the object representation features being configured for representing a posture change situation of the second subject object in the content reference video, and the video reference features including the object representation features; determining a posture change situation of the first subject object in the target video based on the object representation features, the posture change situation of the first subject object in the target video corresponding to the posture change situation of the second subject object in the content reference video. In this way, the posture change situations of the existing content reference video and the target video that is expected to be generated correspond to each other. Therefore, a technical effect of improving video quality of the target video is achieved, so that the series of actions performed by the first subject object in the target video are referred to by the series of actions performed by the second subject object in the content reference video.

In a solution, the performing feature extraction on the second subject object in the content reference video, to obtain object representation features includes the following operations:
S2-1: Perform feature extraction on at least two target video frames including the second subject object in the content reference video, to obtain at least two object static features, the object static features being configured for representing a location form of the second subject object in the target video frames.
S2-2: Integrate the at least two object static features based on time sequence relationship information between the at least two target video frames, to obtain object dynamic features, the object dynamic features being configured for representing the posture change situation of the second subject object in the content reference video, and the object representation features including the object dynamic features.

The object static features are configured for representing the location form of the second subject object in the target video frames. The location form is a static attribute, and is usually sufficient as a basis for generating an image. However, if the location form is used as a basis for generating a video, a dynamic attribute is lacked, because whether a video is coherent is usually determined by the dynamic attribute, and naturally, if the dynamic attribute is lacked, a high-quality video cannot be generated.

Further, in this aspect, the object dynamic features are configured for representing the posture change situation of the second subject object in the content reference video. In other words, in this aspect, the object static features are not directly used as a basis for generating a video, but are configured for obtaining the object dynamic features, and a high-quality video is generated based on a dynamic attribute included in the object dynamic features.

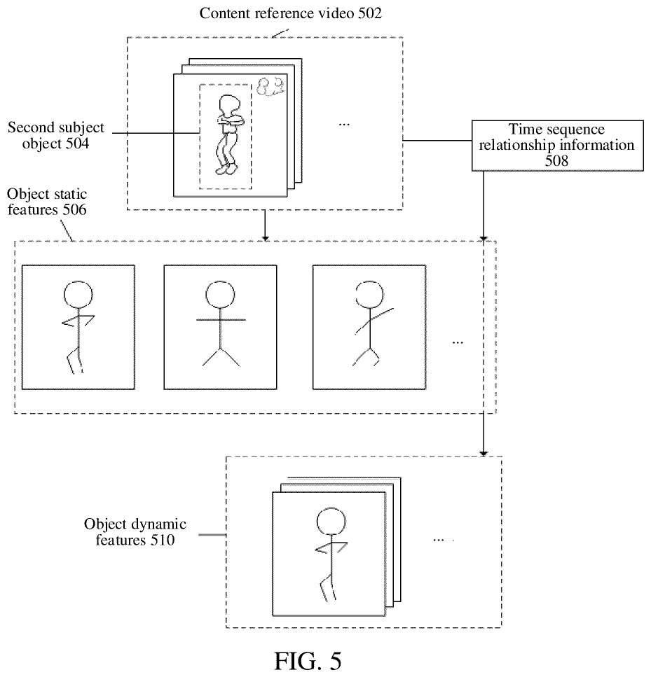

For further example, in an aspect, as shown in FIG. 5, the method includes: performing feature extraction on at least two target video frames including a second subject object 504 in a content reference video 502, to obtain at least two object static features 506, the object static features 506 being configured for representing a location form of the second subject object 504 in the target video frames; sequentially integrating the at least two object static features 506 based on time sequence relationship information 508 between the at least two target video frames, to obtain object dynamic features 510, the object dynamic features 510 being configured for representing a posture change situation of the second subject object 504 in the content reference video 502.

This aspect provided described herein includes: performing feature extraction on at least two target video frames including the second subject object in the content reference video, to obtain the at least two object static features, the object static features being configured for representing the location form of the second subject object in the target video frames; and integrating the at least two object static features based on time sequence relationship information between the at least two target video frames, to obtain object dynamic features, the object dynamic features being configured for representing the posture change situation of the second subject object in the content reference video, and the object representation features including the object dynamic features. In this way, the object dynamic features are obtained by using the object static features and generating a high-quality video based on the dynamic attribute included in the object dynamic features, thereby achieving a technical effect of improving video quality of the target video.

In a solution, the performing feature extraction on at least two target video frames including the second subject object in the content reference video, to obtain at least two object static features includes at least one of the following operations:
S3-1: Perform key point extraction on the second subject object in the at least two target video frames, to obtain at least two key point features, the key point features being configured for representing locations of key points of the second subject object in the target video frames, and the object static features including the key point features.
S3-2: Perform key line extraction on the second subject object in the at least two target video frames, to obtain at least two key line features, the key line features being configured for representing locations of key lines of the second subject object in the target video frames, and the object static features including the key line features.
S3-3: Perform contour extraction on the second subject object in the at least two target video frames, to obtain at least two contour features, the contour features being configured for representing morphological locations of contours of the second subject object in the target video frames, and the object static features including the contour features.
S3-4: Perform edge extraction on the second subject object in the at least two target video frames, to obtain at least two first object features, and the object static features including the first object features.
S3-5: Perform depth extraction on the second subject object in the at least two target video frames, to obtain at least two second object features, and the object static features including the second object features.
S3-6: Perform white model extraction on the second subject object in the at least two target video frames, to obtain at least two third object features, and the object static features including the third object features.

In this aspect, the key point extraction may refer to, but is not limited to, automatically detecting and positioning important feature points from an image, the feature points usually having significant structures, textures, or shape information. For example, a feature detection algorithm, such as Harris corner detection, SIFT (scale-invariant feature transform), SURF (speed up robust feature), may be used to find key points in the image. The foregoing algorithm can determine the key points based on features such as a local structure, a gradient direction, and a scale change of the image.

In this aspect, the key line extraction may refer to, but is not limited to, extracting lines with important visual information from the image, the lines usually being a main contour, an edge, or another important linear structure in the image. For example, a line with visual significance and importance is selected according to a criterion such as a line length, curvature, and a line fitting degree. Line quality and importance may be evaluated by using curvature calculation, a line fitting algorithm, and the like.

In this aspect, the contour extraction may be, but is not limited to, extracting a boundary contour of the object from the image. A contour may be considered as a line segment connecting discontinuous points on a surface of the object, and can represent a shape and structure information of the object. For example, based on a binary image, a contour extraction algorithm may be used to detect and extract the boundary contour of the object, specifically, an edge connection-based contour detection algorithm (such as a Moore-Neighbor algorithm or a kNN detection algorithm) and a pixel connection-based region growth algorithm are used.

In this aspect, the edge extraction may be configured for, but is not limited to, detecting and extracting edge information of the object in the image. An edge usually represents a mutation or discontinuity in an aspect such as brightness, color, or texture in the image, and is a boundary between objects or between an object and a background. Implementations include, for example, Canny edge detection (obtaining a high-quality edge result through a multi-operation process, including operations such as Gaussian filtering, image gradient calculation, non-maximum suppression, double thresholding, and edge connection), a Sobel operator (separately performing convolution calculation on a horizontal direction and a vertical direction of an image to obtain two gradient images, and obtaining an edge strength image by combining the two gradient images), a Laplacian operator (performing a Laplace filtering operation on an image to obtain an edge image), adaptive thresholding (segmenting an image into small regions, and performing threshold selection in each region based on a local statistical characteristic), and the like.

In this aspect, the depth extraction may be, but is not limited to, a process of obtaining depth information from the image or a scene. The depth information represents distances between different points in the object or a scene and the camera. Implementations include, for example, facial depth extraction (using a device such as an infrared camera, structured light, or a time of flight sensor to obtain depth information of a facial region), binocular stereo vision (estimating a depth of a scene by using images of two perspectives, and inferring a distance to an object based on a parallax between left and right eye images, that is, an offset between corresponding pixels), three-dimensional reconstruction (restoring a geometric structure of a three-dimensional scene by using a plurality of image or video sequences, where technologies such as multi-perspective geometry, structured light projection, and optical flow estimation may be used to perform depth extraction and stereo reconstruction), and a deep learning method (using a structure such as a deep convolutional neural network to directly learn and predict depth information from a single image), and the like.

In this aspect, a white model may be, but is not limited to, a prototype model of a building, a product, a sculpture, or the like, and is used as a reference for manufacturing a formal product or structure. The white model may be a model made of a material such as timber, soil, or a polymer.

A plurality of subject object extraction manners are provided, and a corresponding extraction manner can be flexibly used based on an actual application scenario and processing object, to satisfy requirements of the corresponding scenario and processing object, thereby accurately determining the object static features of the second subject object in the target video frames.

In a solution, the generating the target video based on the text semantic features and the video reference features includes the following operation:
inputting the text semantic features and the video reference features to a video generation model, to obtain the target video outputted by the video generation model, the video generation model being a neural network model that is configured for generating a video and obtained by training based on a plurality of pieces of video sample data.

To improve generation efficiency of the target video, the video generation model is used to generate the corresponding target video. The video generation model may be, but is not limited to, a video diffusion model, which generates video data by performing operation-by-operation denoising on random noise.

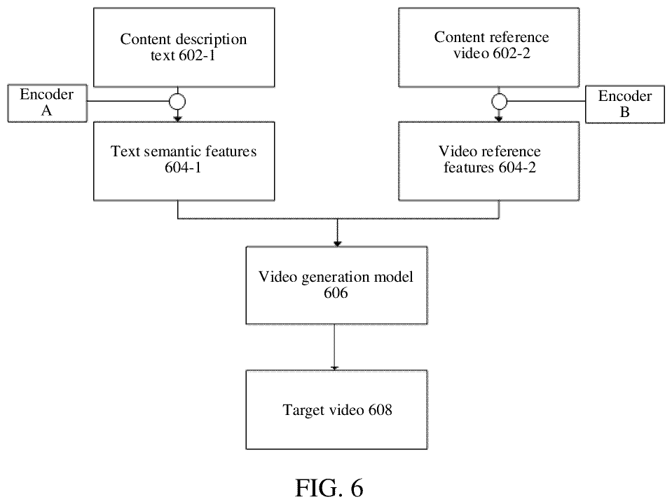

For further example, in an aspect, as shown in FIG. 6, by using an encoder A and an encoder B, feature extraction is performed on an obtained content description text 602-1 and an obtained content reference video 602-2, to obtain text semantic features 604-1 and video reference features 604-2. Further, the text semantic features 604-1 and the video reference features 604-2 are inputted to a video generation model 606, and processed by the video generation model 606, to obtain video features. Then, the video features are converted into video data of a target video 608 by using a decoder.

Based on an aspect described herein, the text semantic features and the video reference features are inputted to the video generation model, to obtain the target video outputted by the video generation model, the video generation model being a neural network model that is configured for generating a video and obtained by training based on a plurality of pieces of video sample data. In this way, the video generation model is used to generate the expected target video, thereby achieving a technical effect of improving generation efficiency of the target video.

In a solution, before inputting the text semantic features and the video reference features to the video generation model, the method further includes the following operations:
S4-1: Obtain an image generation model, the image generation model being a neural network model that is configured for generating an image and obtained by training based on a plurality of pieces of image sample data.
S4-2: Obtain an initial video generation model by adjusting the image generation model, the initial video generation model being formed by a convolution layer and an attention layer that can process time sequence dimensional information.
S4-3: Train the initial video generation model based on the plurality of pieces of video sample data, to obtain the video generation model.

If the video generation model configured for generating the expected video is directly trained, a large amount of training data and high calculation power are usually required to provide support. In this case, in terms of costs or efficiency, training quality of the video generation model cannot be ensured within a proper scope.

In this aspect, a more mature image generation model is adjusted, so that an adjusted image generation model (video generation model) can be applicable to a video generation process. In addition, before improvement, an appropriate amount of image training samples are first used to train the image generation model. After a trained image generation model is obtained, an appropriate amount of video training samples are used to train the adjusted image generation model.

For further example, in an aspect, it is assumed that a convolution layer of the image generation model is 3×3. By means of adjustment, the original convolution layer is extended into a 1×3×3 convolution layer, and a time sequence attention layer is added to the video generation model, to enhance understanding of the model for a sequence frame and stability of generating consecutive video frames, thereby adapting to a video generation process.

The aspect described herein includes: obtaining an image generation model, the image generation model being a neural network model that is configured for generating an image and obtained by training based on a plurality of pieces of image sample data; obtaining an initial video generation model by adjusting the image generation model, the initial video generation model being formed by a convolution layer and an attention layer that can process time sequence dimensional information; and training the initial video generation model based on the plurality of pieces of video sample data, to obtain the video generation model. In this way, adjustment is performed based on a more mature image generation model to obtain the video generation model, thereby achieving a technical effect of ensuring training quality of the video generation model within a proper scope.

In a solution, the inputting the text semantic features and the video reference features to the video generation model, to obtain the target video outputted by the video generation model includes the following operation:
calling a single graphics processing unit, running the video generation model to process the inputted text semantic features and video reference features, to obtain the target video outputted by the video generation model.

After the calling a single graphics processing unit, running the video generation model to process the inputted text semantic features and video reference features, to obtain the target video outputted by the video generation model, the method further includes the following operation:
inserting an associated video frame into a video frame sequence corresponding to the target video, to obtain a new video, a video length corresponding to the new video being greater than a video length corresponding to the target video.

In this aspect, the graphics processing unit (GPU for short) is hardware specially configured to process graphics and parallel computing tasks. The GPU has a large number of cores and a high-speed memory, and can simultaneously process a plurality of data operations, and concurrently execute large-scale computing tasks. GPUs are excellent in processing intensive computing tasks such as large-scale data sets, matrix operations, image processing, and simulation.

In this aspect, inserting an associated video frame may be, but is not limited to, understood as adding an additional frame to the target video. By adding the additional frame to the target video, a frame rate of the target video is changed, so that a video length of the new video outputted can be increased, and motion of the new video can be smoother. Specifically, adding the additional frame to the target video may be implemented by, but is not limited to, linear interpolation, optical flow estimation, frame blending, or the like.

The linear interpolation performs interpolation between adjacent frames, and evenly allocates pixel values based on time. The optical flow estimation estimates a pixel value of an intermediate frame by analyzing an optical flow between two frames based on motion features of pixels. The frame blending, based on movement and deformation of an object in a video sequence, generates an interpolation frame by sampling and blending a plurality of adjacent frames.

To improve coherence of the target video, the single graphics processing unit may be used for processing, but this is not limited thereto. However, performance of the single graphics processing unit is limited, and a data volume of an outputted video is naturally limited, for example, only a target video with a short length can be outputted. However, the target video with a short length usually cannot satisfy a user requirement. Further, in this aspect, frame interpolation is used, to compensate for the foregoing defect that the user requirement cannot be satisfied.

The aspect described herein includes: calling a single graphics processing unit, running the video generation model to process the inputted text semantic features and video reference features, to obtain the target video outputted by the video generation model; inserting an associated video frame into a video frame sequence corresponding to the target video, to obtain a new video, a video length corresponding to the new video being greater than a video length corresponding to the target video. In other words, a frame interpolation manner is used to compensate for a defect of a short video length caused by calling the single graphics processing unit, thereby achieving a technical effect of improving coherence of the target video.

In a solution, for ease of understanding, the foregoing video generation method is applied to a scenario of generating a figure video based on a text. In an existing technical solution, a video generated by using a two-dimensional (2D for short) drawing technology usually has significant inter-frame jitter, and requires a large amount of calculation time. A three-dimensional (3D for short) video generation method faces massive data and calculation power dependency, requires high costs, is difficult to deploy, and has poor generation result stability.

However, in this aspect, as a 2D diffusion model is extended to a 3D video generation network, and a Controlnet control model is combined, data and computational costs required for training the 3D video generation model can be greatly reduced, so that a single data card can be used for driving. In addition, multiplexing based on the 2D diffusion model ensures quality of a generated video, and extension of a time sequence attention module can effectively maintain stability of the video. Compared with previous solutions, this aspect can compensate for defects in terms of effect and efficiency, can generate high-quality video content with ultra-low training and reasoning costs, and can be widely used in video generation tasks of various categories. In addition, this aspect may alternatively be applied to video content of a type other than figures. This is merely described as an example herein, and is not limited thereto.

In this aspect, a video generation model extended based on a 2D latent diffusion model (LDM for short) is constructed, so that data and computational costs required for model training can be greatly reduced, and generation capabilities of massive existing 2D painting models can be effectively multiplexed for video creation. In addition, in this aspect, a control capability is further integrated into the video generation model, and a posture action is extracted from a reference video, to control generated video content, thereby effectively enhancing stability and controllability of the generated video content. Further, in this aspect, the foregoing video generation technology is combined with a frame interpolation algorithm. By extracting a key frame, an initial video with a low frame rate is generated, and then the frame rate of the video is increased by using the frame interpolation algorithm based on a neural network, thereby greatly improving video generation efficiency and fluency.

In this aspect, the video generation model is integrated with a posture control signal, to support a user to input the content reference video and generate video content with reference to the content description text, so that controllability and generation quality of the generated video content can be effectively improved. By extracting a skeleton animation sequence from differentiated content reference videos and with reference to diversified content description texts, this aspect can implement fine control on the video content, and output video content of different styles, characters, and scenarios. Further, in this aspect, the single GPU can generate a high-quality video within minutes. This efficient and low-cost video generation solution has a great application prospect in the fields of video and film making, game PV, and animation production, and can satisfy diversified and customized video production requirements.

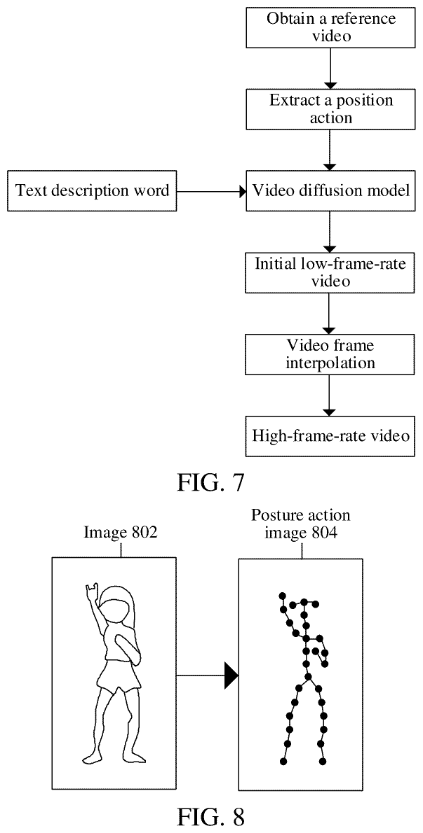

For further example, in an aspect, as shown in FIG. 7, an initial input of this aspect is descriptions of a content reference video and a content description text provided by a user. The content reference video is configured for extracting a posture action, to control a figure action in a generated video. The content description text is configured for controlling specific content such as a figure image, a style, and a background in the generated video. The extracted posture action and text semantic information may uniformly enter a video diffusion model to generate an initial video. Further, post-processing methods such as video frame interpolation and super-resolution reconstruction may be performed on the initial video, to generate a final video effect.

This aspect may be configured for generating video content related to a figure. An inputted content reference video needs to include a figure action, to extract a posture action to control the generated video content. Specifically, in this aspect, human body key points (18 key points including a head and a body) may be extracted from each frame of the content reference video by using, but not limited to, an openpose algorithm, and the key points are visualized as a skeletal connection relationship, to obtain a converted posture action image. The converted posture action image is used as an input of Controlnet, to guide generation of the video content. As a video memory of a single GPU is limited, a quantity of frames in a video generated in a single time has an upper limit (a single A100 GPU can generate 70 frames of video each time). To increase length of the generated video, in this aspect, an 8 fps key frame sequence may be extracted from the content reference video for action sequence extraction, to improve processing efficiency and increase duration of the generated video.

For further example, in an aspect, as shown in FIG. 8, an image 802 of a current video frame is determined from a figure video (that is, a content reference video including a figure), human body key points are extracted from the image 802, and the key points are visualized as a skeleton connection relationship, to obtain a converted posture action image 804.

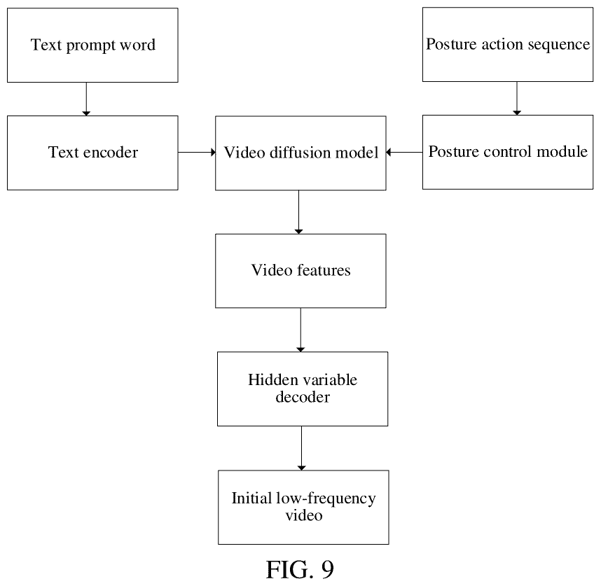

In this aspect, as shown in FIG. 9, a video diffusion model consists of four parts in total, including a hidden variable decoder, a text encoder, a video diffusion model, and a posture control module. First, the text encoder is configured to extract text semantic features from the inputted content description text, and the posture control module helps extract video reference features, that is, action features, from the content reference video. Specifically, this aspect follows a stable diffusion model, uses a CLIP Text Encoder for text encoding, and uses Controlnet as the posture control module. Then, the text semantic features and the video reference features are simultaneously inputted to the video diffusion model for calculation, to obtain hidden variable features of the generated video. The hidden variable features may be finally converted into video content through processing by the hidden variable decoder.

The video diffusion model inherits a basic network structure of a conventional 2D diffusion model (LDM). The structure uses U-Net as a basis, and processes an inputted feature by using a network such as a 2D convolution layer, an upsampling layer, a downsampling layer, and a self-attention mechanism. This conventional 2D network structure can only generate a single image. To directly generate video content, the 2D diffusion model is extended to a 3D video generation model in this aspect. Specifically, in this aspect, an original 3×3 convolution layer in the U-Net is extended to a 1×3×3 convolution layer, and a time sequence attention layer is added to a network, to enhance understanding of a sequence frame by the model and stability of generating consecutive video frames. Before deployment, in this aspect, the network may be trained by using a small amount of video data. In a training process, a parameter of an original 2D U-Net remain fixed, and only a newly added time sequence attention module is trained. Such a design can optimize current 2D model resources, to generate videos of different styles and concepts. In addition, during model training, the parameter of the original 2D diffusion model is fixed, and only a small amount of data needs to be trained to empower the 3D video generation model with a video generation capability.

To further enhance a capability of controlling video content, in this aspect, the posture control module is further embedded into a video generation system, to output highly-controllable video content. Specifically, this aspect uses a Controlnet model. The model can implement action control on drawn image content by inputting a skeletal action in 2D AI painting. In this system, in this aspect, an 8 fps skeleton sequence frame extracted from the content reference video is inputted to the posture control module, which performs frame-by-frame processing on the skeleton sequence and stitches features of a plurality of frames together, to guide calculation of the video generation model. An output of the model is hidden variable features of video content, and may be finally converted into a low-frame-rate (8 fps) initial video by using the hidden variable decoder.

In this aspect, to further improve smoothness of a video, a frame rate of the generated initial video is extended to 32 fps by means of video frame interpolation. Specifically, in this aspect, the generated initial video is first disassembled into single frames, and subsequently, frame interpolation is performed on a frame sequence by four times by using a FILM algorithm based on a neural network, to combine newly generated frames into a high-frame-rate video, so that the smoothness can be greatly improved.

In this aspect described herein, as the 2D diffusion model is extended to the 3D video generation model, and the Controlnet control model is combined, data and computational costs required for training the 3D video generation model can be greatly reduced, so that a single data card can be used for driving. In addition, multiplexing based on the 2D diffusion model ensures quality of a generated video, and extension of a time sequence attention module can effectively maintain stability of the video. Compared with previous solutions, this aspect compensates for defects in terms of provide effect and efficiency, can generate high-quality video content with ultra-low training and reasoning costs, and can be widely used in video generation tasks of various categories.

In a specific implementation described herein, related data such as user information is involved. When the foregoing aspects described herein are applied to a specific product or technology, user permission or consent is required to be obtained, and relevant collection, use, and processing of data are required to comply with relevant laws, regulations, and standards of relevant countries and regions.

For ease of description, the foregoing method aspects are stated as a series of action combinations. However, this application is not limited to the described sequence of the actions, because according to this application, some operations may be performed in another sequence or may be simultaneously performed. In addition, aspects described in this specification are all illustrative, and the involved actions and modules are not necessarily limited as such.

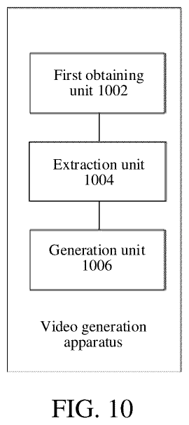

According to another aspect of aspects described herein, a video generation apparatus for implementing the foregoing video generation method is further provided. As shown in FIG. 10, the apparatus includes:
a first obtaining unit 1002, configured to obtain a content description text and a content reference video, the content description text including information for describing target content expressed by a target video that is expected to be generated, and the content reference video including action reference information related to the target content;
an extraction unit 1004, configured to: perform feature extraction on the content description text, to obtain text semantic features, the text semantic features being configured for representing semantic information of the content description text; and perform feature extraction on the content reference video, to obtain video reference features, the video reference features being configured for representing the action reference information in the content reference video; and
a generation unit 1006, configured to generate the target video based on the text semantic features and video reference features.

For specific aspects, refer to the example shown in the foregoing video generation apparatus, which is not described again in this aspect.

In a solution, the generation unit 1006 includes:
a first determining module, configured to determine at least one video element in the target video based on the text semantic features, the at least one video element including a first subject object;
a second determining module, configured to determine a posture change situation of the first subject object in the target video based on the video reference features; and
an obtaining module, configured to generate the target video based on the at least one video element and the posture change situation of the first subject object in the target video.

For specific aspects, refer to the example shown in the foregoing video generation method, which is not described again in this aspect.

In a solution, the obtaining unit 1004 includes:
an extraction module, configured to perform feature extraction on a second subject object in the content reference video, to obtain object representation features, object representation features being configured for representing a posture change situation of the second subject object in the content reference video, and video reference features including the object representation features.

The generation unit 1006 includes:
a third determining module, configured to determine the posture change situation of the first subject object in the target video based on the object representation features, the posture change situation of the first subject object in the target video corresponding to the posture change situation of the second subject object in the content reference video.

For specific aspects, refer to the example shown in the foregoing video generation method, which is not described again in this aspect.

In a solution, the extraction module includes:
an extraction submodule, configured to perform feature extraction on at least two target video frames including the second subject object in the content reference video, to obtain at least two object static features, the object static features being configured for representing a location form of the second subject object in the target video frames; and
a processing submodule, configured to integrate the at least two object static features based on time sequence relationship information between the at least two target video frames, to obtain object dynamic features, the object dynamic features being configured for representing the posture change situation of the second subject object in the content reference video, and the object representation features including the object dynamic features.

For specific aspects, refer to the example shown in the foregoing video generation method, which is not described again in this aspect.

In a solution, the extraction submodule includes at least one of the following:
a first extraction subunit, configured to perform key point extraction on the second subject object in the at least two target video frames, to obtain at least two key point features, the key point features being configured for representing locations of key points of the second subject object in the target video frames, and the object static features including the key point features;
a second extraction subunit, configured to perform key line extraction on the second subject object in the at least two target video frames, to obtain at least two key line features, the key line features being configured for representing locations of key lines of the second subject object in the target video frames, and the object static features including the key line features;
a third extraction subunit, configured to perform contour extraction on the second subject object in the at least two target video frames, to obtain at least two contour features, the contour features being configured for representing morphological locations of contours of the second subject object in the target video frames, and the object static features including the contour features;
a fourth extraction subunit, configured to perform edge extraction on the second subject object in the at least two target video frames, to obtain at least two first object features, the object static features including the first object features;
a fifth extraction subunit, configured to perform depth extraction on the second subject object in the at least two target video frames, to obtain at least two second object features, the object static features including the second object features; and
a sixth extraction subunit, configured to perform white model extraction on the second subject object in the at least two target video frames, to obtain at least two third object features, the object static features including the third object features.

For specific aspects, refer to the example shown in the foregoing video generation method, which is not described again in this aspect.

In a solution, the generation unit 1006 includes:
an input module, configured to input the text semantic features and the video reference features to a video generation model, to obtain the target video outputted by the video generation model, the video generation model being a neural network model that is configured for generating a video and obtained by training based on a plurality of pieces of video sample data.

For specific aspects, refer to the example shown in the foregoing video generation method, which is not described again in this aspect.

In a solution, the apparatus further includes:
a second obtaining unit, configured to obtain an image generation model before inputting the text semantic features and the video reference features to the video generation model, the image generation model being a neural network model that is configured for generating an image and obtained by training based on a plurality of pieces of image sample data;
a determining unit, configured to obtain an initial video generation model by adjusting the image generation model, the initial video generation model being formed by a convolution layer and an attention layer that can process time sequence dimensional information; and
a training unit, configured to train the initial video generation model based on the plurality of pieces of video sample data, to obtain the video generation model.

For specific aspects, refer to the example shown in the foregoing video generation method, which is not described again in this aspect.

In a solution, the input module includes:
an input submodule, configured to call a single graphics processing unit, running the video generation model to process the inputted text semantic features and video reference features, to obtain the target video outputted by the video generation model.

The apparatus further includes a frame interpolation submodule, configured to: call a single graphics processing unit, run the video generation model to process the text semantic features and video reference features, to obtain the target video outputted by the video generation model; and then insert an associated video frame into a video frame sequence corresponding to the target video, to obtain a new video, a video length corresponding to the new video being greater than a video length corresponding to the target video.

For specific aspects, refer to the example shown in the foregoing video generation method, which is not described again in this aspect.

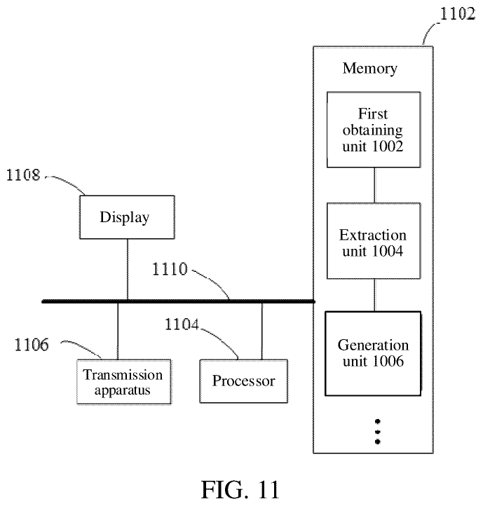

According to still another aspect of aspects described herein, an electronic device configured to implement the foregoing video generation method is further provided. The electronic device may be, but is not limited to, the user device 102 or the server 112 shown in FIG. 1. This aspect is described by using an example in which the electronic device is the user device 102. Further, as shown in FIG. 11, the electronic device includes the memory 1102 and the processor 1104, the memory 1102 storing a computer program, and the processor 1104 being configured to perform the operations of any one of the foregoing method aspects by using the computer program.

In this aspect, the foregoing electronic device may be located in at least one of a plurality of network devices in a computer network.

In an aspect, a person skilled in the art may understand that, the structure shown in FIG. 11 is only schematic, and FIG. 11 does not constitute a limitation to a structure of the foregoing electronic device. For example, the electronic device may further include more or fewer components (for example, a network interface) than those shown in FIG. 11, or has a configuration different from that shown in FIG. 11.

The memory 1102 may be configured to store a software program and a module, such as program instructions/modules corresponding to the video generation method and apparatus in aspects described herein. The processor 1104 executes various functional applications and data processing by running the software program and the module stored in the memory 1102, that is, implements the video generation method. The memory 1102 may include a high speed random access memory, and may further include a non-volatile memory, for example, one or more magnetic storage apparatuses, flash memories, or other non-volatile solid-state memories. In some instances, the memory 1102 may further include memories remotely disposed relative to the processor 1104, and these remote memories may be connected to the electronic device through a network. Instances of the foregoing network include but are not limited to, the Internet, an intranet, a local area network, a mobile communications network, and a combination thereof. The memory 1102 may be specifically configured to, but is not limited to, store information such as a content description text, a content reference video, and a target video. In an example, as shown in FIG. 11, the memory 1102 may include, but is not limited to, the first obtaining unit 1002, the extraction unit 1004, and the generation unit 1006 in the foregoing video generation apparatus. In addition, the memory may further include, but is not limited to, other modules and units in the foregoing video generation apparatus. Details are not described again in this example.

In an aspect, the transmission apparatus 1106 is configured to receive or send data through a network. Specific examples of the foregoing network may include a wired network and a wireless network. In an instance, the transmission apparatus 1106 includes a network interface controller (NIC), which may be connected to another network device and router through a cable, to communicate with the Internet or a local area network. In an instance, the transmission apparatus 1106 is a radio frequency (RF) module that is configured to communicate with the Internet in a wireless manner.

In addition, the foregoing electronic device further includes: a display 1108, configured to display information such as the foregoing content description text, the content reference video, and the target video; and a connection bus 1110, configured to connect each module component in the foregoing electronic device.

In another aspect, the foregoing user device or server may be a node in a distributed system. The distributed system may be a blockchain system, and the blockchain system may be a distributed system formed by connecting a plurality of nodes through network communication. A peer to peer network may be formed between the nodes. A computing device in any form, for example, an electronic device such as a server or a user device, may become a node in the blockchain system by joining the peer to peer network.

According to an aspect described herein, a computer program product is provided, the computer program product including a computer program or instructions, and the computer program or instructions including a program code configured for performing the method as shown in the flowchart. In such an aspect, the computer program may be downloaded and installed from a network through a communication part, and/or installed from a removable medium. When executed by a central processing unit, the computer program executes functions provided in aspects described herein.

The sequence numbers of the foregoing aspects described herein are merely for description purpose, but do not indicate the preference of the aspects.

A computer system of the electronic device is merely an example, and does not constitute any limitation on functions and use ranges of aspects described herein.

The computer system includes a central processing unit (CPU), which may execute various proper actions and processing based on a program stored in a read-only memory (ROM) or a program loaded from a storage part into a random-access memory (RAM). The RAM further stores various programs and data required for system operations. The CPU, the ROM, and the RAM are connected to each other via a bus. An input/output (I/O) interface is also connected to the bus.

The following components are connected to the I/O interface: an input part including a keyboard, a mouse, or the like; an output part including a cathode ray tube (CRT), a liquid crystal display (LCD), a speaker, or the like; a storage part including a hard disk, or the like; and a communication part including a network interface card such as a local area network card or a modem. The communication part performs communication processing by using a network such as the Internet. A driver is also connected to the I/O interface as required. A removable medium, such as a magnetic disk, an optical disc, a magneto-optical disk, or a semiconductor memory, is installed on the drive as required, so that a computer program read from the removable medium is installed into the storage part as required.

Particularly, according to aspects described herein, the processes described in the various method flowcharts may be implemented as computer software programs. For example, this aspect described herein includes a computer program product, which includes a computer program carried on a computer-readable medium, and the computer program includes program code configured for performing the methods shown in the flowchart. In such an aspect, the computer program may be downloaded and installed from a network through a communication part, and/or installed from a removable medium. When the computer program is executed by the CPU, the various functions defined in the system described herein are executed.

According to an aspect described herein, a computer-readable storage medium is provided. A processor of a computer device reads computer instructions from the computer-readable storage medium, and executes the computer instructions, to enable the computer device to perform the methods provided in various implementations in the foregoing aspects.

In this aspect, a person of ordinary skill in the art may understand that all or some operations of the methods of the foregoing aspects may be performed by a program instructing relevant hardware of an electronic device. The program may be stored in a computer-readable storage medium, and the storage medium may include: a flash disk, a read-only memory (ROM), a random access memory (RAM), a magnetic disk, or an optical disc.

The sequence numbers of the foregoing aspects described herein are merely for description purpose, but do not indicate the preference of the aspects.

When the integrated unit in the foregoing aspects is implemented in a form of a software functional unit and sold or used as an independent product, the integrated unit may be stored in the foregoing computer-readable storage medium. Based on such an understanding, the technical solutions described herein essentially, or a part contributing to the prior art, or all or some of the technical solutions may be implemented in a form of a software product. The computer software product is stored in a storage medium and includes several instructions for instructing one or more computer devices (which may be a personal computer, a server, a network device, or the like) to perform all or some of the operations of the methods described in aspects described herein.

In the foregoing aspects described herein, the description of each aspect has respective focuses. For a part that is not described in detail in an aspect, refer to related descriptions in other aspects.

In the several aspects provided described herein, the disclosed user device may be implemented in another manner. The foregoing described apparatus aspect is merely illustrative. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the units or modules may be implemented in electronic or another form.

The units described as separate components may or might not be physically separate, and components displayed as units may or might not be physical units, may be located in one position, or may be distributed on a plurality of network units. Some of or all of the units may be selected based on actual requirements to achieve objectives of the solutions of aspects.

In addition, functional units in aspects described herein may be integrated into one processing unit, or each of the units may exist alone physically, or two or more units may be integrated into one unit. The integrated unit may be implemented in a form of hardware, or may be implemented in a form of a software functional unit.

The foregoing descriptions are merely illustrative implementations described herein. A person of ordinary skill in the art may further make several improvements and modifications without departing from the principle described herein, and the improvements and modifications are considered to fall within the protection scope described herein.

What is claimed is:

1. A computer-implemented video generation method, comprising:
obtaining content description text and a content reference video, the content description text comprising information describing target content to be expressed by a target video that is expected to be generated, and the content reference video comprising action reference information related to the target content;
performing feature extraction on the content description text, to obtain one or more text semantic features, the one or more text semantic features representing semantic information of the content description text;
performing feature extraction on the content reference video to obtain one or more video reference features, the one or more video reference features representing the action reference information in the content reference video; and
generating the target video based on the one or more text semantic features and the one or more video reference features.

2. The method according to claim 1, wherein the generating the target video comprises:
determining at least one video element in the target video based on the one or more text semantic features, the at least one video element comprising a first subject object;
determining a posture change situation of the first subject object in the target video based on the one or more video reference features; and
generating the target video based on the at least one video element and the posture change situation of the first subject object in the target video.

3. The method according to claim 2, wherein the performing feature extraction on the content reference video comprises:
performing feature extraction on a second subject object in the content reference video, to obtain one or more object representation features, the one or more object representation features being configured for representing a posture change situation of the second subject object in the content reference video, and the one or more video reference features comprising the object representation features; and
the determining the posture change situation comprises:
determining the posture change situation of the first subject object in the target video based on the one or more object representation features, the posture change situation of the first subject object in the target video corresponding to the posture change situation of the second subject object in the content reference video.

4. The method according to claim 3, wherein the performing feature extraction on the second subject object comprises:
performing feature extraction on at least two target video frames comprising the second subject object in the content reference video, to obtain at least two object static features, the object static features representing a location form of the second subject object in the target video frames; and
integrating the at least two object static features based on time sequence relationship information between the at least two target video frames, to obtain one or more object dynamic features, the one or more object dynamic features being configured for representing the posture change situation of the second subject object in the content reference video, and the one or more object representation features comprising the object dynamic features.

5. The method according to claim 4, wherein the performing feature extraction on the at least two target video frames comprises:
performing key point extraction on the second subject object in the at least two target video frames, to obtain at least two key point features, the key point features being configured for representing locations of key points of the second subject object in the target video frames, and the object static features comprising the key point features.

6. The method according to claim 4, wherein the performing feature extraction on the at least two target video frames comprises:
performing key line extraction on the second subject object in the at least two target video frames, to obtain at least two key line features, the key line features being configured for representing locations of key lines of the second subject object in the target video frames, and the object static features comprising the key line features.

7. The method according to claim 4, wherein the performing feature extraction on the at least two target video frames comprises:
performing contour extraction on the second subject object in the at least two target video frames, to obtain at least two contour features, the contour features being configured for representing morphological locations of contours of the second subject object in the target video frames, and the object static features comprising the contour features.

8. The method according to claim 4, wherein the performing feature extraction on the at least two target video frames comprises:
performing edge extraction on the second subject object in the at least two target video frames, to obtain at least two first object features, the object static features comprising the first object features.

9. The method according to claim 4, wherein the performing feature extraction on the at least two target video frames comprises:
performing depth extraction on the second subject object in the at least two target video frames, to obtain at least two second object features, the object static features comprising the second object features.

10. The method according to claim 4, wherein the performing feature extraction on the at least two target video frames comprises:
performing white model extraction on the second subject object in the at least two target video frames, to obtain at least two third object features, the object static features comprising the third object features.

11. The method according to claim 1, wherein the generating the target video based on the text semantic features and the video reference features comprises:
inputting the one or more text semantic features and the one or more video reference features into a video generation model, to obtain the target video outputted by the video generation model, the video generation model being a neural network model that is configured for generating a video and obtained by training based on a plurality of pieces of video sample data.

12. The method according to claim 11, wherein before the inputting the text semantic features and the video reference features into the video generation model, the method further comprises:
obtaining an image generation model, the image generation model being a neural network model that is configured for generating an image and obtained by training based on a plurality of pieces of image sample data;
obtaining an initial video generation model for the image generation model, the initial video generation model being formed by a convolution layer and an attention layer that can process time sequence dimensional information; and
training the initial video generation model based on the plurality of pieces of video sample data, to obtain the video generation model.

13. The method of claim 11, wherein the inputting the one or more text semantic features and the one or more video reference features to the video generation model comprises:
calling a single graphics processing unit, running the video generation model to process the one or more text semantic features and the one or more video reference features, to obtain the target video outputted by the video generation model; and
after the calling a single graphics processing unit, running the video generation model to process the one or more text semantic features and the one or more video reference features, to obtain the target video outputted by the video generation model, and
wherein the method further comprises:
inserting an associated video frame into a video frame sequence corresponding to the target video, to obtain a new video, a video length corresponding to the new video being greater than a video length corresponding to the target video.

14. One or more non-transitory computer readable media comprising computer readable instructions that, when executed by a processor, configure a data processing system to perform:
obtaining content description text and a content reference video, the content description text comprising information describing target content to be expressed by a target video that is expected to be generated, and the content reference video comprising action reference information related to the target content;
performing feature extraction on the content description text, to obtain one or more text semantic features, the one or more text semantic features representing semantic information of the content description text;
performing feature extraction on the content reference video to obtain one or more video reference features, the one or more video reference features representing the action reference information in the content reference video; and
generating the target video based on the one or more text semantic features and the one or more video reference features.

15. The computer readable media according to claim 14, wherein the generating the target video comprises:
determining at least one video element in the target video based on the one or more text semantic features, the at least one video element comprising a first subject object;
determining a posture change situation of the first subject object in the target video based on the one or more video reference features; and
generating the target video based on the at least one video element and the posture change situation of the first subject object in the target video.

16. The computer readable media according to claim 14, wherein the generating the target video based on the text semantic features and the video reference features comprises:
inputting the one or more text semantic features and the one or more video reference features into a video generation model, to obtain the target video outputted by the video generation model, the video generation model being a neural network model that is configured for generating a video and obtained by training based on a plurality of pieces of video sample data.

17. The computer readable media according to claim 16, wherein before the inputting the text semantic features and the video reference features into the video generation model, the instructions further configure the data processing system to perform:
obtaining an image generation model, the image generation model being a neural network model that is configured for generating an image and obtained by training based on a plurality of pieces of image sample data;
obtaining an initial video generation model for the image generation model, the initial video generation model being formed by a convolution layer and an attention layer that can process time sequence dimensional information; and
training the initial video generation model based on the plurality of pieces of video sample data, to obtain the video generation model.

18. A system, comprising:
a processor; and
memory storing computer readable instructions that, when executed by the processor, configure the system to perform:
obtaining content description text and a content reference video, the content description text comprising information describing target content to be expressed by a target video that is expected to be generated, and the content reference video comprising action reference information related to the target content;
performing feature extraction on the content description text, to obtain one or more text semantic features, the one or more text semantic features representing semantic information of the content description text;
performing feature extraction on the content reference video to obtain one or more video reference features, the one or more video reference features representing the action reference information in the content reference video; and
generating the target video based on the one or more text semantic features and the one or more video reference features.

19. The computer readable media according to claim 18, wherein the generating the target video comprises:
determining at least one video element in the target video based on the one or more text semantic features, the at least one video element comprising a first subject object;
determining a posture change situation of the first subject object in the target video based on the one or more video reference features; and
generating the target video based on the at least one video element and the posture change situation of the first subject object in the target video.

20. The computer readable media according to claim 18, wherein the generating the target video based on the text semantic features and the video reference features comprises:
inputting the one or more text semantic features and the one or more video reference features into a video generation model, to obtain the target video outputted by the video generation model, the video generation model being a neural network model that is configured for generating a video and obtained by training based on a plurality of pieces of video sample data.
